(19) United States
(12) Patent Application Publication
(10) Pub. No.: US 2026/0134266 A1
(43) Pub. Date: May 14, 2026

(54) EVENT PREDICTION METHOD USING DECOUPLED MARKED TEMPORAL POINT PROCESS AND HARDWARE APPARATUS

(71) Applicant: POSTECH RESEARCH AND BUSINESS DEVELOPMENT FOUNDATION, Pohang-si, Gyeongsangbuk-do (KR)

(72) Inventors: Won Hwa KIM, Pohang-si, Gyeongsangbuk-do (KR); Yu Jee SONG, Pohang-si, Gyeongsangbuk-do (KR); Dong Hyun LEE, Pohang-si, Gyeongsangbuk-do (KR); Seung Hun BAEK, Pohang-si, Gyeongsangbuk-do (KR)

(21) Appl. No.: 19/388,012

(22) Filed: Nov. 13, 2025

(30) Foreign Application Priority Data
Nov. 14, 2024 (KR) 10-2024-0161722
Aug. 6, 2025 (KR) 10-2025-0108586

(51) Int. Cl. G06N 3/048; G06F 9/54; G06F 17/13; G06F 18/2415

(52) U.S. Cl. CPC G06N 3/048; G06F 9/542; G06F 17/13; G06F 18/2415

(57) ABSTRACT

A method for predicting future event occurrence using decoupled marked temporal point process. The method may include: generating an initial hidden state according to an event type for each of events included in a past event sequence; developing hidden states by applying the initial hidden state to a neural ordinary differential equation for each of the events; computing influence functions over time by decoding each of the developed hidden states; computing a ground intensity function by combining the influence functions of the events; computing a probability distribution of the event types by combining the influence functions of the events; and predicting an event occurrence time and event type at a future time based on the ground intensity function and the probability distribution of the event types.

### CROSS REFERENCE TO RELATED APPLICATIONS

This application claims priority to and the benefit of (i) Korean Patent Application No. 10-2024-0161722, filed Nov. 14, 2024, and (ii) Korean Patent Application No. 10-2025-0108586, filed Aug. 6, 2025, each filed in the Korean Intellectual Property Office, under 35 U.S.C. § 119(a). The entire disclosure of each of the foregoing applications is incorporated herein by reference in its entirety.

### BACKGROUND

### Technical Field

The present disclosure relates to a technique for predicting event occurrence based on a Marked Temporal Point Process (MTPP).

### Description of the Related Art

Event-time data consists of multiple types of events on a timeline found in various application fields such as social media, healthcare, and stock fluctuations. The purpose of modeling such temporal data as a stochastic process is to predict the timing and type of future event occurrences based on previously observed event history.

Traditionally, event prediction has been addressed using Temporal Point Process (TPP), which is a stochastic process realized as an ordered set of times. The discussion of related art is provided for background only and is not an admission of prior art. The description of the related art includes information that describes one or more aspects of the subject technology, and the description in this section does not limit the invention.

### SUMMARY

In one or more aspects of the present disclosure, a method for predicting future event occurrence using decoupled marked temporal point process includes: an analysis device generating an initial hidden state according to an event type for each of events included in a past event sequence; the analysis device developing the hidden state by applying the initial hidden state to a neural ordinary differential equation for each of the events; the analysis device computing influence functions over time by decoding each of the developed hidden states; the analysis device computing a ground intensity function by combining the influence functions of the events; the analysis device computing a probability distribution of the event types by combining the influence functions of the events; and the analysis device predicting an event occurrence time and event type at a future time based on the ground intensity function and the probability distribution of the event types.

In one or more aspects of the present disclosure, a hardware apparatus for predicting future event occurrence includes: a storage device that stores a past event sequence including occurrence times and event types for each of past events; and a computing device that develops hidden states by applying initial hidden states to a neural ordinary differential equation for each of the events, derives influence functions over time by decoding each of the developed hidden states, computes a ground intensity function by combining the influence functions of the events, computes a probability distribution of the event types by combining the influence functions of the events, and predicts an event occurrence time and event type at a future time based on the ground intensity function and the probability distribution of the event types.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 illustrates an example of an MTPP-based event prediction system.

FIG. 2 illustrates an example of a process of expressing the contribution of each event in MTPP as hidden state dynamics.

FIG. 3 illustrates an example of deriving a solution to a multidimensional ordinary differential equation with integration.

FIG. 4 illustrates a visualization example of conditional probability propagation of marks in the Stack Overflow dataset.

FIGS. 5A-5C illustrate a visualization of patterns found in the Retweet dataset.

FIG. 6 illustrates an example of a model for predicting temporal changes in Alzheimer's disease biomarkers.

FIGS. 7A-7B illustrate an example of visual information for Alzheimer's biomarker prediction results.

FIG. 8 illustrates FDG predicted over time in brain regions of interest.

FIG. 9 illustrates an example of a hardware device that predicts events.

Throughout the drawings and the detailed description, unless otherwise described, the same drawing reference numerals should be understood to refer to the same elements, features, and structures. The sizes of regions and elements, and depiction thereof may be exaggerated for clarity, illustration, and/or convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be understood by those of ordinary skill in the art.

Moreover, descriptions of well-known functions and constructions may be omitted for increased clarity and conciseness. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, locations, and areas), proportions, ratios, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., components, structures, groups, circuits, networks, members, parts, areas, portions, integers, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., components, structures, groups, circuits, networks, members, parts, areas, portions, and/or the like) are described using any of the terms such as “adjacent to,” “beside,” “next to,” and/or the like indicating a position or location, one or more other elements may be located between the two elements unless a more limiting term, such as “immediate(ly),” “direct(ly),” or “close(ly),” is used. Furthermore, the spatially relative terms such as the foregoing terms as well as other terms such as “column,” “row,” “vertical,” “horizontal,” “diagonal,” and the like refer to an arbitrary frame of reference.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., components, structures, groups, circuits, networks, members, parts, areas, portions, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., component, structure, group, circuit, network, member, part, area, portion, and/or the like) “is engaged” with another element may be understood, for example, as that the element may be either directly or indirectly engaged with the another element. The term “is engaged” or similar expressions may refer to a term such as “is connected,” “is coupled,” “is combined,” “is linked,” “is provided,” “interacts,” or the like. The engagement may involve one or more intervening elements disposed or interposed between the element and the another element, unless otherwise specified.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” may indicate a degree of being considered as being equivalent to each other taking into account minute differences due to errors in the manufacturing or operating process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale and dimension of each of the elements illustrated in the accompanying drawings may be different from an actual scale and dimension, and thus, embodiments of the present disclosure are not limited to a scale and dimension illustrated in the drawings.

Before starting detailed explanations of figures, components that will be described in the specification are distinguished merely according to functions mainly performed by the components. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

The description described herein is an MTPP-based event occurrence prediction technique.

The description further employs Neural Ordinary Differential Equations (Neural ODEs) to model continuous event dynamics

Hereinafter, the operation of an analysis device that performs event occurrence prediction is described. The analysis device may be implemented in various hardware apparatus such as a computer device, a PC (Personal Computer), a smart device, a server on a network, etc.

Events may arise in various domains, including finance, healthcare/medicine, equipment monitoring, logistics, and e-commerce. The following description is not limited to a specific field.

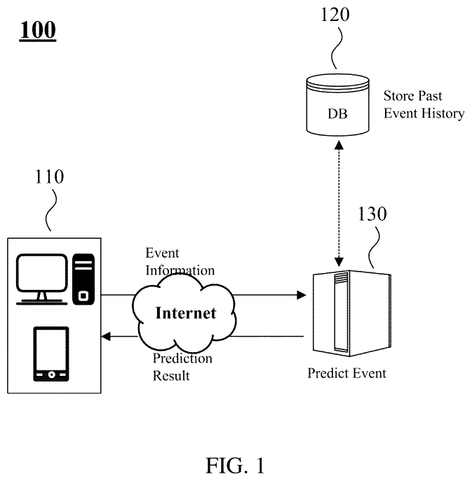

FIG. 1 illustrates an example of an MTPP-based event prediction system 100. In FIG. 1, service server 130 corresponds to the analysis device.

User terminal 110 is a computer device used by a user. User terminal 110 may be a device such as a PC or smart device.

User terminal 110 may receive event information for prediction from a user. User terminal 110 may also receive a past event history associated with a particular domain or subject.

User terminal 110 transmits the event information to service server 130.

Alternatively, user terminal 110 may only receive identification information of events to be predicted. In this case, user terminal 110 transmits the event identification information to service server 130.

Service server 130 may predict future event occurrence using event information and historical data.

Database (DB) 120 can store past event history.

Service server 130 may retrieve a past event history for the corresponding event from DB 120 based on event identification information from user terminal 110. Thereafter, service server 130 may predict whether a specific event will occur in the future using the received event information.

In another embodiment, service server 130 may additionally compute explanatory information such as each event's contribution or influence on the predicted future event. For example, service server 130 can calculate the contribution (influence) of each past event to future event occurrence.

Service server 130 can transmit the predicted event occurrence information to user terminal 110. Also, service server 130 can transmit the predicted additional information to user terminal 110.

Alternatively, the user terminal 110 may locally perform the prediction using an embedded program. In this case, user terminal 110 corresponds to the analysis device.

Hereinafter, the event occurrence prediction process using neural ODEs is described in detail.

TPP (Temporal Point Process) refers to a stochastic process represented by an ordered sequence of event times {t₁, t₂, . . . , tₙ}. Events observed up to time tᵢ are denoted as history [symbol] ={t₁, . . . , tᵢ}.

The time when the next event will occur depending on the event history can be represented by a conditional probability density function ƒ(t| [symbol] ):=ƒ*(t). This represents the probability that the next event occurs within the interval [t, t+dt).

The cumulative density function is denoted as F(t| [symbol] ), and the survival function is defined as S(t| [symbol] )=1−F(t| [symbol] ). Hereinafter, the subscript * indicates that the function is conditioned on [symbol] . These definitions follow the formulation in Rasmussen (2018) and Yang et al. (2022).

Defining a fixed functional form of f*(t) is difficult due to the ambiguity of the pattern and the normalization constraint

$${\int }_{0}^{∞} {f}^{*} ( s ) d s = 1 .$$

Therefore, an intensity function

$${λ}^{*} ( t ) : = \frac{{f}^{*} ( t )}{{s}^{*} ( t )} = \frac{{f}^{*} ( t )}{1 - {F}^{*} ( t )}$$

is introduced to represent the stochastic process. This has only a single constraint of λ*(t)≥0 and is widely used as a method for flexibly modeling TPP (Yang et al., Transformer embeddings of irregularly spaced events and their participants. In International Conference on Learning Representations, 2022, etc.). The conditional intensity function λ*(t) utilizes observed events [symbol] to calculate intensity at time t, and is interpreted as λ*(t)dt=p(tᵢ∈[t, t+dt]| [symbol] ).

A MTPP is a stochastic process with realization as a set of events S={e₁, e₂, . . . , eₙ}, where each event eᵢ=(tᵢ, kᵢ) consists of event occurrence time tᵢ∈ [symbol] and event type (mark) kᵢ∈{1, . . . , K}.

The entire event sequence before time tᵢ is defined as history [symbol] ={(tⱼ, kⱼ)∈ [symbol] : tⱼ<tᵢ}. The conditional intensity function λ*(t, k):=λ(t, k| [symbol] ) of MTPP conditioned on mark k can be expressed as the product of two components as shown in Equation 1 below (Rasmussen et al., Lecture notes: Temporal point processes and the conditional intensity function, 2018).

$${λ}^{*} ( t , k ) = {λ}_{ℊ}^{*} ( t ) {f}^{*} ( k \vert t ) = \frac{f ( t \vert ) {f}^{*} ( k \vert t )}{1 - F ( t \vert )} = \frac{f ( t , k \vert )}{1 - F ( t \vert )} \qquad [ Equation 1 ]$$

Here, ƒ*(t) is the probability over time, and ƒ*(k|t) is the conditional probability over marks. Since λ*(t,k) can be expressed as two separate components,

$${λ}_{g}^{*} ( t ) and {f}^{*} ( k \vert t )$$

the likelihood of MTPP can be expressed as shown in Equation 2 below.

$$f ( t , k ) = [ {Π}_{i = 1}^{{N}_{ℊ} ( {t}_{N} )} {λ}_{ℊ}^{*} ( {t}_{i} ) ] [ {Π}_{i = 1}^{{N}_{ℊ} ( {t}_{N} )} {f}^{*} ( {k}_{i} \vert {t}_{i} ) ] exp ( - {\int }_{0}^{{t}_{N}} {λ}_{ℊ}^{*} ( u ) du ) \qquad [ Equation 2 ]$$

Here, N_{g} is a counting process according to the ground intensity function

$${λ}_{ℊ}^{*} ( t )$$

defined ignoring marks.

The Hawkes process is widely used for modeling point processes with self-exciting characteristics. The Hawkes process describes a TPP process in which each event induces subsequent events. The Hawkes process can be defined by the intensity function λ*(t) as shown in Equation 3 below.

$${λ}^{*} ( t ) = v + {Σ}_{{t}_{i} < t} μ ( t - {t}_{i} ) \qquad [ Equation 3 ]$$

Here, t is the time of interest, v is a constant greater than or equal to 0, μ(t) is a triggering function that models the effect of past events on future event occurrence rates, and tᵢ are the times of past events.

Neural Ordinary Differential Equations is a deep learning approach that combines neural networks and differential equations to use continuous depth models instead of fixed layer structures. Mathematically, the continuous transformation of output values is defined by an ordinary differential equation as shown in Equation 4 below.

$$\frac{dz ( t )}{dt} = γ ( z ( t ) , t ; θ ) \qquad [ Equation 4 ]$$

Here, γ(⋅|θ) is a neural network that approximates the rate of change of hidden state z(t) over time t, and θ is its parameter.

The hidden state represents the influence of each event eᵢ in the overall process.

A sequence of consecutive events is represented as S={e₁, e₂, . . . , eₙ}, where one event eᵢ=(tᵢ, kᵢ) consists of one time point and one mark.

Given n+1 observed events, the analysis device predicts the probability distribution of event eₙ₊₁.

Unlike conventional studies that directly estimate conditional intensity λ*(t, k), the analysis device separately predicts ground intensity

$${λ}_{ℊ}^{*} ( t )$$

and event distribution ƒ*(k|t). The proposed prediction model represents the influence that each event has over time as hidden state dynamics h(t; eᵢ). The prediction model decodes

$${λ}_{ℊ}^{*} ( t ) and {f}^{*} ( k \vert t )$$

respectively and combines them to generate λ*(t, k).

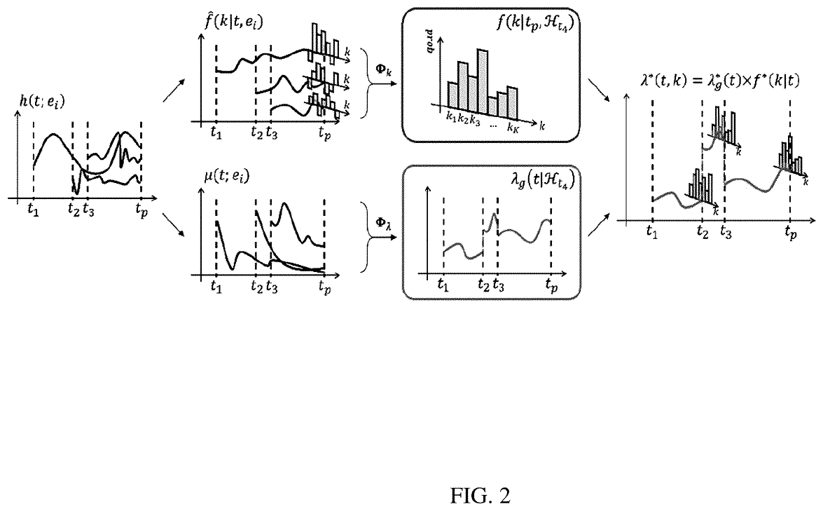

FIG. 2 illustrates an example of a process of expressing the contribution of each event in MTPP as hidden state dynamics. As shown in FIG.

$$2 , {λ}_{ℊ}^{*} ( t ) and {f}^{*} ( k \vert t )$$

represent independent trajectories that are subsequently combined to form the joint intensity λ*(t, k).

Each event eᵢ can influence the overall process. Hidden states are used to represent the influence of each event.

The hidden state h(t; eᵢ)∈R^{d} defined for each event eᵢ evolves independently over time from its occurrence time tᵢ. The evolution of h(t; eᵢ) is modeled using a Neural ODE, allowing flexible and continuous representation of the temporal dynamics of the intensity function within the MTPP.

Specifically, the initial magnitude of hidden state h(tᵢ; eᵢ) is determined according to the event type kᵢ, and the dynamics are analyzed through an Initial Value Problem (IVP) solver. The hidden state generated by event eᵢ at time t can be expressed by Equations 5 and 6 below.

$$dh ( t ; {e}_{i} ) = γ ( h ( t ; {e}_{i} ) , t , {k}_{i} ; θ ) dt \qquad [ Equation 5 ]$$

$$h ( t ; {e}_{i} ) = h ( {t}_{i} ; {e}_{i} ) + {\int }_{{t}_{i}}^{t} γ ( h ( s ; {e}_{i} ) , s , {k}_{i} ; θ ) ⅆ s = {W}_{e} ( {k}_{i} ) = {\int }_{{t}_{i}}^{t} γ ( h ( s ; {e}_{i} ) , s , {k}_{i} ; θ ) ⅆ s \qquad [ Equation 6 ]$$

The size of the initial hidden state is obtained through a learnable function Wₑ(⋅):{1, . . . , K}→R^{d}. Wₑ maps each mark to a d-dimensional hidden state space. γ is parameterized by neural network θ. Function γ is a differential term that defines the rate of change of the hidden state.

The hidden state at time t can be computed in parallel as a multidimensional neural ordinary differential equation as shown in Equation 7 below.

$$\frac{d}{dt} h ( t ) = \frac{d}{dt} [ \begin{matrix}h ( t ; {e}_{0} ) \\ ⋮ \\ h ( t ; {e}_{1} )\end{matrix} ] = [ \begin{matrix}γ ( h ( t ; {e}_{0} ) , t , {k}_{0} ; θ ) \\ ⋮ \\ γ ( h ( t ; {e}_{i} ) , t , {k}_{i} ; θ )\end{matrix} ] \qquad [ Equation 7 ]$$

This decoupled structure allows selective consideration of influence from h(t). For example, when calculating ƒ*(t) conditioned on [symbol] , where t>tⱼ₊₁, h(t; eₜ_{ᵢ₊₁}) should not be included in computation. This selective conditioning preserves causality and prevents information leakage from future events, aligning with the neural ODE-based inference pipeline.

The ground intensity function

$${λ}_{g}^{*} ( t )$$

is defined as a composition of decoupled influence functions μ(t;eᵢ). This can be regarded as a generalized form of the triggering function used in Hawkes processes. The influences of past events can be combined by conditioning the ground intensity on past event history. The conditioned ground intensity function can be expressed as shown in Equation 8 below.

$${λ}_{g} ( t \vert {n + 1}_{} ) = {λ}_{g} ( t \vert {e}_{0} , ⋯ , {e}_{n} ) = {Φ}_{λ} ( μ ( t ; {e}_{0} ) , ⋯ , μ ( t ; {e}_{n} ) ) \qquad [ Equation 8 ]$$

μ(t; eᵢ)==g_{μ}(h(t; eᵢ)) is generated (decoded) by decoder neural network g_{μ}: R^{d}→R. eᵢ is one event observed in past event history, and Φ_{λ} is a positive function satisfying the non-negative condition of

$${λ}_{g}^{*} ( t ) .$$

Hidden state h(t;eᵢ) is decoded to μ(t;eᵢ) before constituting

$${λ}_{g}^{*} ( t ) ,$$

otherwise the influence of a specific event is not observed.

Integration operations are essential in the TPP learning process. Not only the calculation of probability distribution

$${f}^{*} ( t ) : = {λ}^{*} ( t ) exp ( - {\int }_{{t}_{t - 1}}^{t} {λ}^{*} ( s ) d s )$$

but also the derivation of characteristic functions such as survival rate generally require integration without closed-form solutions. Here, survival rate means the probability that an event does not occur until a specific time. Therefore, intensity-based methods require separate sampling such as Monte Carlo techniques for each prediction.

The neural ordinary differential equations used to derive the solution of MTPP require much computation compared to Monte Carlo techniques. To reduce the computational burden, the characteristics of ordinary differential equations were utilized. As shown in Equation 9 below, the following multidimensional ordinary differential equation for h(t) was solved simultaneously with numerical integration to eliminate the need for additional sampling.

$$\begin{matrix}\frac{\partial }{\partial t} [ \begin{matrix}h ( t ) \\ {Λ}_{g} ( t \vert {ℋ}_{{t}_{i}} ) \\ F ( t \vert {ℋ}_{{t}_{i}} ) \\ 𝔼 [ t ]\end{matrix} ] = [ \begin{matrix}γ ( h ( t ) , t , k ; θ ) \\ {λ}_{g} ( t \vert {ℋ}_{{t}_{i}} ) \\ f ( t \vert {ℋ}_{{t}_{i}} ) \\ t \cdot f ( t \vert {ℋ}_{{t}_{i}} )\end{matrix} ] \\ = [ \begin{matrix}γ ( h ( t ) , t , k ; θ ) \\ {Φ}_{λ} ( {g}_{μ} ( h ( t ) ) ) \\ {λ}_{g} ( t \vert {ℋ}_{{t}_{i}} ) \cdot exp ( {Λ}_{g} ( {t}_{i - 1} \vert {ℋ}_{{t}_{i}} ) - {Λ}_{g} ( t \vert {ℋ}_{{t}_{i}} ) ) \\ t \cdot f ( t \vert {ℋ}_{{t}_{i}} )\end{matrix} ]\end{matrix} \qquad [ Equation 9 ]$$

$$where {Λ}_{g} ( t \vert ) := {\int }_{0}^{t} ( {λ}_{g} ( t \vert ) dt$$

is the compensator, and k are event marks corresponding to h(t). E[t] means the expected time point when an event is expected to occur. Since dynamics are learned through differential equations, values at time t can be utilized for other operations. For example, the derivative of

$${Λ}_{g}^{*} ( t ) , which is {λ}_{g}^{*} ( t ) ,$$

can be computed using h(t).

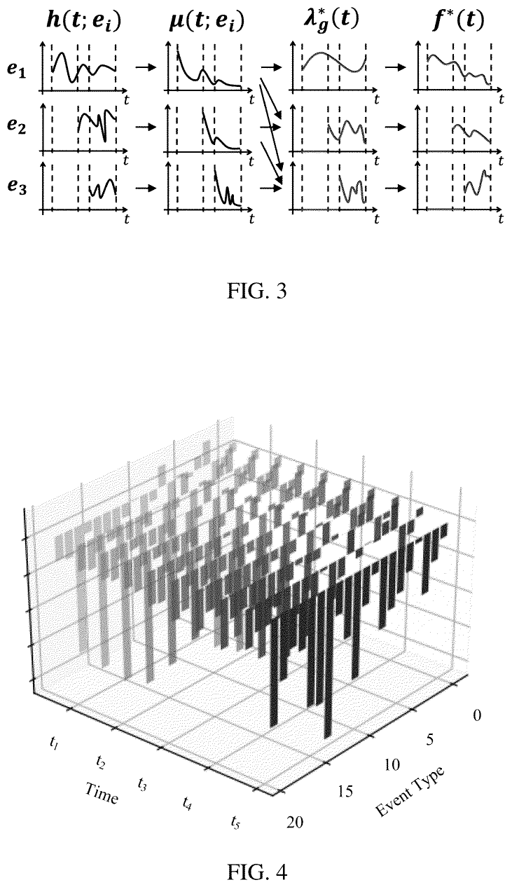

FIG. 3 illustrates an example of deriving a solution to a multidimensional ordinary differential equation with integration. FIG. 3 is a visualization of Equation 9. Various combinations of μ(t;eᵢ) may be combined to compute the ground intensity

$${λ}_{g}^{*} ( t )$$

and the conditional probability f*(t) under different historical contexts [symbol] .

Major estimated values including integration (e.g., likelihood, survival rate S*(t):=1−F*(t), and expected value E_{ƒ*}[t] can be predicted with a single run. This formulation is applicable to any number of integration problems. Also, the influence function can be selected according to the user's purpose.

Therefore, function approximations at various histories Hₜⱼ in Equation 9 can be calculated in parallel. Unlike existing intensity-based methods that must be executed separately for each, neural ordinary differential equations are characterized by such parallel processing.

In summary, the analysis device can calculate the compensator and derive the event occurrence probability density function f(t), survival function S(t), and event occurrence expected time point E[t] based on the calculated compensator.

Similar to the ground intensity function

$${λ}_{g}^{*} ( t ) ,$$

the conditional probability of marks ƒ*(k|t) is expressed as shown in Equation 10 below:

$$f ( k \vert t , {n + 1}_{} ) = {Φ}_{k} ( \hat{f} ( k \vert t , {e}_{0} ) , ⋯ , \hat{f} ( k \vert t , {e}_{n} ) ) \qquad [ Equation 10 ]$$

where \hat{ƒ}(k|t, eᵢ):=g_{ƒ}(hₜ(eᵢ)) is the influence of event eᵢ on ƒ(k|t), decoded by neural network g_{ƒ}(⋅). Φₖ is a normalized function such that the sum of probabilities for all marks equals 1. This modeling has the following meaning. For example, an event of obtaining a driver's license sharply increases the probability of traffic accidents, but as driving skills improve over time, that probability decreases again. In the proposed structure, such semantic changes over time can be captured through \hat{ƒ}(k|tᵢ, eᵢ).

As described above, to separate the influence of individual events,

$${λ}_{g}^{*} ( t )$$

and ƒ*(k|t) are defined as separate influence functions.

In another embodiment, the combination functions Φ_{λ} and Φₖ can be implemented in various forms from simple summation functions to complex neural networks such as Transformers. The description centers on linear decoupled ordinary differential equations that can model hidden states in parallel. Linear decoupled ordinary differential equations can be implemented as neural network-based models as described above.

To demonstrate the performance of the proposed decoupled ordinary differential equation-based technique, Φ_{λ} and Φₖ can be defined by simply combining the influences of past events for

$${λ}_{g}^{*} ( t )$$

and ƒ*(k|t). The ground intensity function

$${λ}_{g}^{*} ( t )$$

and the conditional probability of marks ƒ*(k|t) can be defined as a combination of decoupled dynamics as shown in Equations 11 and 12 below.

$$\begin{matrix}{λ}_{g} ( t \vert {n + 1}_{} ) = {Φ}_{λ} ( μ ( t ; {e}_{0} ) , ⋯ , μ ( t ; {e}_{n} ) ) \\ = {\sum }_{{e}_{i} ∈ {ℋ}_{{t}_{n + 1}}} softplus ( μ ( t , {e}_{i} ) )\end{matrix} \qquad [ Equation 11 ]$$

$$\begin{matrix}f ( k \vert t , {ℋ}_{{t}_{n + 1}} ) = {Φ}_{k} ( \hat{f} ( k \vert t , {e}_{0} ) , ⋯ , \hat{f} ( k \vert t , {e}_{n} ) ) \\ = softmax ! ( {\sum }_{{e}_{i} ∈ {ℋ}_{{t}_{n + 1}}} \hat{f} ( k \vert t , {e}_{i} ) )\end{matrix} \qquad [ Equation 12 ]$$

Here, softplus and softmax functions were used to satisfy the constraints presented in the ground intensity function and conditional probability of marks, respectively.

Modeling

$${λ}_{g}^{*} ( t )$$

as a linear sum is similar to the structure of Hawkes processes, but can model temporal dynamics more flexibly, making it more suitable for complex real-world situations.

The learning objective of linear decoupled ordinary differential equations is to maximize the likelihood of MTPP. Taking the logarithm of Equation 2 gives Equation 13 below.

$$ln f ( t , k ) = ln [ ( {\prod }_{i = 1}^{{N}_{g} ( {t}_{N} )} {λ}_{g}^{*} ( {t}_{i} ) ) ( {\prod }_{i = 1}^{{N}_{g} ( {t}_{N} )} {f}^{*} ( {k}_{i} \vert {t}_{i} ) ) exp ( - {\int }_{0}^{{t}_{N}} {λ}_{g}^{*} ( u ) du ) ] = {\underbrace{{\sum }_{i = 1}^{{N}_{g} ( {t}_{N} )} ln {λ}_{g}^{*} ( {t}_{i} ) - {\int }_{0}^{{t}_{N}} {λ}_{g}^{*} ( u ) du}}_{l n {L}_{λ}} + {\underbrace{{\sum }_{i = 1}^{{N}_{g} ( {t}_{N} )} ln {f}^{*} ( {k}_{i} \vert {t}_{i} )}}_{l n {L}_{k}} \qquad [ Equation 13 ]$$

Here, t_{N} is the last observation time, and the log-likelihood is defined separately into a term ln L_{λ} for ground intensity and a term ln Lₖ for mark distribution. Each is utilized for learning λ_{g}(t) and ƒ(k|t).

Intuitively, the first term of ln L_{λ} means the probability that an event occurs at each tᵢ, and the second term means the probability that an event does not occur in all other time intervals. Therefore,

$${λ}_{g}^{*} ( t )$$

should be high at time points when events occur and low at time points when they do not, to maximize L_{λ}. Also, f(t) is adjusted to satisfy the normalization condition ∫f(t)dt=1.

Existing differential equation-based TPP models had very long learning times because they had to sequentially calculate the entire time range. In contrast, the proposed technique can alleviate learning time constraints by utilizing the characteristic Φ_{λ} is linear addition as follows.

First, since each μ(t;eᵢ) can be calculated independently of other events, parallel propagation is possible as a multidimensional differential equation as shown in Equation 14 below.

$$d [ \begin{matrix}μ ( {τ}_{0} ; {e}_{0} ) \\ ⋮ \\ μ ( {τ}_{i} ; {e}_{i} )\end{matrix} ] = [ \begin{matrix}γ ( μ ( {τ}_{0} ) , {τ}_{0} , {k}_{0} ; θ ) \\ ⋮ \\ γ ( μ ( {τ}_{i} ) , {τ}_{i} , {k}_{i} ; θ )\end{matrix} ] \cdot d τ \qquad [ Equation 14 ]$$

$$where τ = {[ {τ}_{0} , ⋯ , {τ}_{i} ]}^{⊤} = {[ {t}_{0} + t , {t}_{1} + t , ⋯ , {t}_{i} + t ]}^{⊤} .$$

Second, because the ground intensity function is configured as a linear equation, the compensator

$${Λ}_{g}^{*} ( t )$$

can also be calculated as shown in Equation 15 below.

$${Λ}_{g}^{*} ( t ) = {\int }_{0}^{t} {λ}_{g}^{*} ( s ) ds = {\int }_{0}^{t} {\sum }_{{e}_{i} ∈ {ℋ}_{𝓉}} softplus ( μ ( s ; {e}_{i} ) ) ds = {\int }_{{t}_{i}}^{t} softplus ( μ ( s ; {e}_{i} ) ) ds \qquad [ Equation 15 ]$$

Here, the integration range starts from time point tᵢ when event eᵢ occurred because it exerts influence from that point, so it does not contribute before that time point. This equation means that the integration of

$${λ}_{g}^{*} ( t )$$

can be calculated by individually integrating softplus(μ(t;eᵢ)) for each event and then summing them. Therefore, without needing to sequentially process the entire sequence, the entire trajectory can be calculated within a fixed number of steps knowing only the number of time points m.

In another embodiment, a technique for learning temporal dynamics utilizing conventional neural ordinary differential equations has been proposed in prior research (Chen et al., Neural spatio-temporal point processes. In International Conference on Learning Representations, 2021). This technique proposed a continuous-depth method by continuously interpreting the amount of change in state vectors between neural network layers. Therefore, detailed description of the specific learning technique for the aforementioned neural ordinary differential equations is omitted.

Hereinafter, validation results of the constructed decoupled neural ordinary differential equations are described.

Five real-world datasets were used in the experiments. The datasets used were Reddit (sequence of social media posts), Stack Overflow (sequence of rewards received on a Q&A platform), MIMIC-II (sequence of diagnoses during intensive care unit (ICU) clinical visits), MOOC (user interaction sequence on an online lecture platform), and Retweet (social media retweet sequence). Time points in the datasets were normalized based on the time interval differences of the datasets.

Evaluation metrics used were NLL (Negative Log-Likelihood), RMSE (Root Mean Squared Error), and ACC (Accuracy). NLL was used to validate the predicted probability density function as shown in Equation 13, RMSE was used to measure the reliability of predicted event time points, and ACC was used to measure the accuracy of mark distribution f*(k|t).

Comparison models used were THP (Transformer Hawkes Process, Zuo et al., 2020), IFL (Intensity-Free Learning, Shchur et al., 2020), and ANHP (Attentive Neural Hawkes Process, Yang et al., 2022). Both THP and ANHP are Transformer-based models that predict event eₙ₊₁ utilizing the entire history.

The performance of the proposed technique and conventional models is shown in Table 1 below. Dec-ODE (Decoupled-Neural Ordinary Differential Equation, proposed technique) showed superior performance compared to conventional models in most cases. This means that the proposed technique effectively models complex MTPP dynamics through a structure that individually propagates inter-event influences.

TABLE 1

| | | | | | |
|---|---|---|---|---|---|
| Dataset | RMTPP | THP | IFL | ANHP | Dec-ODE |

RMSE

| | | | | | |
|---|---|---|---|---|---|
| MOOC | 0.473 (0.012) | 0.476 (0.010) | 0.501 (0.012) | 0.470 (0.019) | 0.467 (0.012) |
| Reddit | 0.953 (0.016) | 6.151 (0.195) | 1.040 (0.017) | 1.149 (0.010) | 0.934 (0.017) |
| Retweet | 0.990 (0.016) | 1.055 (0.015) | 1.012 (0.018) | 1.663 (0.014) | 0.985 (0.016) |
| MIMIC-II | 0.859 (0.093) | >10 (0.114) | 1.005 (0.121) | 0.933 (0.088) | 0.810 (0.173) |
| Stack Overflow | 1.017 (0.011) | 1.057 (0.011) | 1.340 (0.013) | 1.052 (0.011) | 1.018 (0.011) |

ACC

| | | | | | |
|---|---|---|---|---|---|
| MOOC | 20.98 (0.29) | 24.49 (0.22) | 32.30 (1.30) | 31.53 (0.20) | 42.08 (0.44) |
| Reddit | 29.67 (1.19) | 60.72 (0.08) | 48.91 (1.27) | 63.45 (0.16) | 62.32 (0.11) |
| Retweet | 51.72 (0.33) | 60.68 (0.11) | 55.35 (0.19) | 59.72 (0.11) | 60.17 (0.23) |
| MIMIC-II | 78.20 (5.00) | 85.98 (2.56) | 80.49 (5.20) | 84.30 (2.78) | 85.06 (3.65) |
| Stack Overflow | 53.95 (0.32) | 53.83 (0.18) | 53.00 (0.35) | 56.80 (0.18) | 55.58 (0.29) |

NLL

| | | | | | |
|---|---|---|---|---|---|
| MOOC | −0.315 (0.031) | 0.733 (0.047) | −2.895 (0.031) | −2.632 (0.043) | −2.289 (0.191) |
| Reddit | 3.559 (0.070) | 2.335 (0.031) | 2.188 (0.088) | 1.203 (0.068) | 1.367 (0.126) |
| Retweet | −2.180 (0.025) | −2.597 (0.016) | −2.672 (0.023) | −3.134 (0.019) | −2.897 (0.030) |
| MIMIC-II | 1.167 (0.150) | 5.657 (0.304) | 0.939 (0.139) | 1.025 (0.155) | 1.354 (0.413) |
| Stack Overflow | 2.156 (0.022) | 2.318 (0.022) | 2.314 (0.020) | 1.873 (0.017) | 2.063 (0.016) |

Meanwhile, since the proposed technique corresponds to a neural network-based model, it can provide information about which events influenced how much. FIG. 4 illustrates a visualization example of conditional probability propagation of marks in the Stack Overflow dataset. FIG. 4 shows how individual events influence future occurrence probabilities over time and mark type.

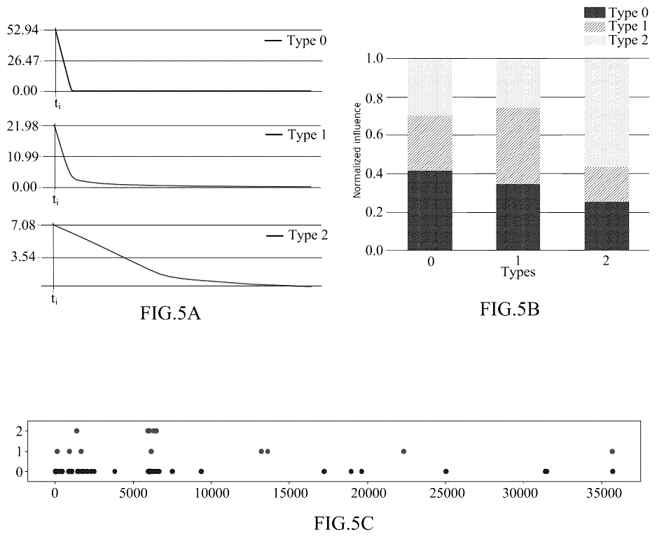

Also, the proposed technique provides interpretable information about inter-event interactions and self-excitation patterns between marks. FIGS. 5A-5C illustrate a visualization of patterns found in the Retweet dataset.

The Retweet dataset consists of three marks: users with few followers (about 50%, Type 0), medium (about 45%, Type 1), and many followers (about 5%, Type 2).

FIG. 5A shows the influence of each event. The influence μ(t;eᵢ) that event eᵢ for each mark gives to λ_{g}(t) all decreases over time, showing that events from users with many followers (Type 2) have a slow rate of decrease.

FIG. 5B visualizes the mutual influence ratio by mark. Although Type 2 accounts for only 5% of the total proportion, it had a large influence on overall event occurrence.

FIG. 5C visualizes each event. Each mark showed a tendency to have the strongest interaction with itself. FIG. 5C clearly shows the clustering effect through event visualization on a time series.

### Application Example: Alzheimer's Biomarker Prediction

Using the aforementioned MTPP-based event prediction technique, a model for a specific task was constructed. The specific model was one that predicts temporal changes in Alzheimer's disease biomarkers: beta-amyloid protein (β-amyloid), FDG (F-18 Fluorodeoxyglucose), and Tau protein.

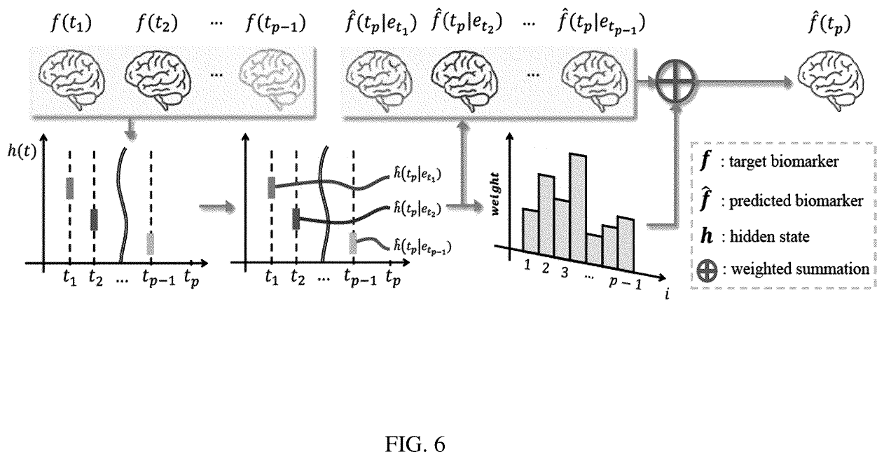

FIG. 6 illustrates an example of a model for predicting temporal changes in Alzheimer's disease biomarkers.

The longitudinal data that is time series is multimodal brain imaging and can be denoted as

$${𝓃}_{} := {\{ {e}_{{t}_{i}} \}}_{i = 1}^{n} . {t}_{1} < {t}_{2} < ⋯ < {t}_{n}$$

are time points, and e; represents an event (image acquisition) at time t. Each event eₜ_{ᵢ}={mₜ_{ᵢ}, ƒₜ_{ᵢ}, δₜ_{ᵢ}, tᵢ} consists of modality type (e.g., standardized uptake value ratio of beta-amyloid) mₜ, values measured in N regions of interest ƒₜ_{ᵢ}∈ [symbol] ^{N}, diagnosed Alzheimer's disease stage δₜ_{ᵢ}, and observed time point tᵢ.

Each event eₜ_{ᵢ} is encoded into hidden state hᵢ∈ [symbol] ^{d} using neural network g_{enc}(⋅) as shown in Equation 16 below.

$$h ( {t}_{p} \vert {e}_{{t}_{i}} ) = {g}_{enc} ( {e}_{{t}_{i}} ) = {g}_{enc} ( [ {f}_{{t}_{i}} \vert {ξ}_{m} ( {m}_{{t}_{i}} ) \vert {ξ}_{δ} ( {δ}_{{t}_{i}} ) ] ) \qquad [ Equation 16 ]$$

ξₘ(⋅):R→R^{dim}^{ₘ} and ξ_{δ}(⋅):R→R^{dim}^{_{δ}} are learnable mapping functions that transform modality and diagnostic information into vectors of dimₘ and dim_{δ} dimensions, respectively.

Measurements in the brain change over time due to aging or disease. As shown in Equations 17 and 18 below, the evolution of hidden states is modeled through neural ordinary differential equations.

$$dh ( {t}_{p} \vert {e}_{{t}_{i}} ) = γ ( h ( {t}_{p} \vert {e}_{{t}_{i}} ) , {ξ}_{δ} ( {δ}_{{t}_{i}} ) ; θ ) dt \qquad [ Equation 17 ]$$

$$h ( {t}_{p} \vert {e}_{{t}_{i}} ) = h ( {t}_{p} \vert {e}_{{t}_{i}} ) + {\int }_{{t}_{i}}^{{t}_{p}} γ ( h ( s \vert {e}_{{t}_{i}} ) , {ξ}_{δ} ( {δ}_{{t}_{i}} ) ; θ ) ds \qquad [ Equation 18 ]$$

Here, γ(⋅) is a neural ordinary differential equation module parameterized by neural network θ. Function γ(⋅) models the patient's rate of state change and can reflect different progression speeds by disease stage by integrating diagnostic information δ through learning.

Solving the IVP of this neural ordinary differential equation can obtain a trajectory of latent states up to future time points. This reveals how the target latent state h(⋅) changes over time.

Function γ(⋅) uses only current state h(s|eₜ_{ᵢ}) and diagnostic information ξ_{δ}(δₜ_{ᵢ}) as inputs. This means that the entire process depends conditionally only on the initial event eₜ_{ᵢ} and proceeds independently of other observations.

The autoregressive nature of neural ordinary differential equations can increase computational cost. Therefore, as shown in Equation 19 below, the rate of change can be modeled as a multidimensional neural ordinary differential equation system. Equation 19 computes the rate of change of h(tₚ|eₜ_{ᵢ}) at time tₚ in parallel for each eₜ_{ᵢ}, reducing complexity for observation count n from O(n²) to O(n).

$$\frac{d}{dt} h ( {t}_{p} ) = \frac{d}{dt} [ \begin{matrix}h ( {t}_{p} \vert {e}_{{t}_{1}} ) \\ ⋮ \\ h ( {t}_{p} \vert {e}_{{t}_{p - 1}} )\end{matrix} ] = [ \begin{matrix}γ ( h ( {t}_{p} \vert {e}_{{t}_{1}} ) , {ξ}_{δ} ( {δ}_{{t}_{1}} ) ) \\ ⋮ \\ γ ( h ( {t}_{p} \vert {e}_{{t}_{p - 1}} ) , {ξ}_{δ} ( {δ}_{{t}_{p - 1}} ) )\end{matrix} ] \qquad [ Eqaution 19 ]$$

Given propagated latent state h(tₚ|eₜ_{ᵢ}), we predict measurement ƒ(ₜₚ) at time tₚ based on the corresponding event eₜ_{ᵢ} as shown in Equation 20 below.

$$\hat{f} ( {t}_{p} \vert {e}_{{t}_{i}} ) = {g}_{dec} ( h ( {t}_{p} \vert {e}_{{t}_{i}} ) ) \qquad [ Equation 20 ]$$

g_{dec}: [symbol] ^{d}→ [symbol] ^{N} represents a decoder network that maps latent states to ROI measurements. Also, for more reliable estimation, all predictions derived from previous observations are aggregated.

Then, as shown in Equation 21 below, the final prediction \hat{ƒ}(tₚ) is obtained by combining predictions

$${\{ \hat{f} ( {t}_{p} \vert {e}_{{t}_{i}} ) \}}_{i = 1}^{p - 1}$$

from past observations.

$$\hat{f} ( {t}_{p} \vert {- 1}_{} ) = {\sum }_{{t}_{i} < {t}_{p}} {w}_{i , p} \cdot \hat{f} ( {t}_{p} \vert {e}_{{t}_{i}} ) \qquad [ Equation 21 ]$$

Here, w_{i,p} represents the weight (contribution) of each past observation, through which \hat{ƒ}(tₚ| [symbol] ₋₁) effectively integrates entire sequence information. Also, using attention mechanisms, the complexity relationship between target prediction time and modalities can be confirmed, and the most influential factors can be identified.

$${w}_{: , p} = softmax ( \frac{Q ( [ h ( {t}_{p} ) \vert {ξ}_{t} ( {t}_{1 : p - 1} ) ] ) {K ( [ {ξ}_{t} ( {t}_{p} ) \vert {ξ}_{m} ( {m}_{p} ) ] )}^{⊤}}{\sqrt{{dim}_{h}}} ) \qquad [ Equation 22 ]$$

Here, h(⋅) is the multidimensional latent state calculated in Equation 19, and Q(⋅) and K(⋅) are single-layer linear models that generate query and key matrices, respectively.

The performance of the constructed prediction model was validated. ADNI data (Mueller et al, The alzheimer's disease neuroimaging initiative. Neuroimaging Clinics 15(4), 869-877p, 2005) was used. The data includes standardized uptake value ratio (SUVR) values for β-amyloid protein (AMY), FDG, and tau protein (TAU) in 160 brain regions based on the Destrieux atlas. The data was measured through positron emission tomography (PET). The dataset consists of information for Cognitive Normal (CN), Subjective Memory Complaint (SMC), Early Mild Cognitive Impairment (EMCI), Late MCI (LMCI), and Alzheimer's Dementia (AD) as shown in Table 2 below.

TABLE 2

| Biomarker | Category | CN | SMC | EMCI | LMCI | AD | Total |
|---|---|---|---|---|---|---|---|
| FDG | # of subjects | 255 | 4 | 189 | 277 | 115 | 840 |
| | # of records | 782 | 4 | 455 | 1016 | 607 | 2864 |
| TAU | # of subjects | 60 | 47 | 49 | 31 | 21 | 208 |
| | # of records | 140 | 112 | 122 | 76 | 56 | 506 |
| AMY | # of subjects | 220 | 89 | 237 | 158 | 56 | 760 |
| | # of records | 672 | 240 | 741 | 379 | 274 | 2306 |

Given an observed sequence in the range t∈[t₁, tₚ) for continuous trajectory f(t), we predict ƒ(tₚ| [symbol] ₋₁). Since observations are made at discrete time points, we optimize the model to predict the last event f(tₚ) from the previous p−1 events.

The prediction model was predicted using input sequences containing only a single modality and sequences composed of multiple modalities. The prediction model's performance was compared with RNN (Rumelhart et al., Learning representations by back-propagating errors, nature 323(6088), 533-536, 1986), Transformer (Vaswani et al., Attention is all you need. NeurIPS 30, 2017), and Mamba (Gu et al, Mamba: Linear-time sequence modeling with selective state spaces, In COLM, 2024). Table 3 below shows the performance comparison results. Enc-ODE is the model using the proposed neural ordinary differential equations. The proposed model showed higher performance compared to conventional models. Also, it showed higher performance when using multimodal data.

TABLE 3

| | | Target | | | | | |
|---|---|---|---|---|---|---|---|
| | | FDG | | TAU | | AMY | |
| Metric | | RMSE | MAE | RMSE | MAE | RMSE | MAE |
| Unimodal | RNN | 0.1053 ± 0.0018 | 0.0796 ± 0.0014 | 0.1962 ± 0.0042 | 0.1211 ± 0.0022 | 0.2220 ± 0.0007 | 0.1650 ± 0.0003 |
| | Transformer | 0.1051 ± 0.0012 | 0.0793 ± 0.0008 | 0.1754 ± 0.0021 | 0.1248 ± 0.0282 | 0.2198 ± 0.0016 | 0.1638 ± 0.0014 |
| | Mamba | 0.0926 ± 0.0027 | 0.0698 ± 0.0019 | 0.1487 ± 0.0036 | 0.0979 ± 0.0020 | 0.2078 ± 0.0013 | 0.1544 ± 0.0011 |
| | Enc-ODE | 0.0792 ± 0.0004 | 0.0602 ± 0.0003 | 0.1360 ± 0.0010 | 0.0914 ± 0.0004 | 0.2104 ± 0.0014 | 0.1560 ± 0.0009 |
| | (proposed) | | | | | | |
| Multimodal | RNN | 0.1019 ± 0.0001 | 0.0772 ± 0.0002 | 0.2115 ± 0.0019 | 0.1348 ± 0.0013 | 0.2267 ± 0.0008 | 0.1673 ± 0.0005 |
| | Transformer | 0.1002 ± 0.0009 | 0.0761 ± 0.0006 | 0.1892 ± 0.0078 | 0.1198 ± 0.0036 | 0.2153 ± 0.0013 | 0.1607 ± 0.0014 |
| | Mamba | 0.0992 ± 0.0016 | 0.0745 ± 0.0015 | 0.1949 ± 0.0058 | 0.1306 ± 0.0039 | 0.2281 ± 0.0023 | 0.1659 ± 0.0015 |
| | Enc-ODE | 0.0766 ± 0.0006 | 0.0583 ± 0.0005 | 0.1321 ± 0.2300 | 0.0909 ± 0.0013 | 0.1996 ± 0.0900 | 0.1445 ± 0.0008 |
| | (proposed) | | | | | | |

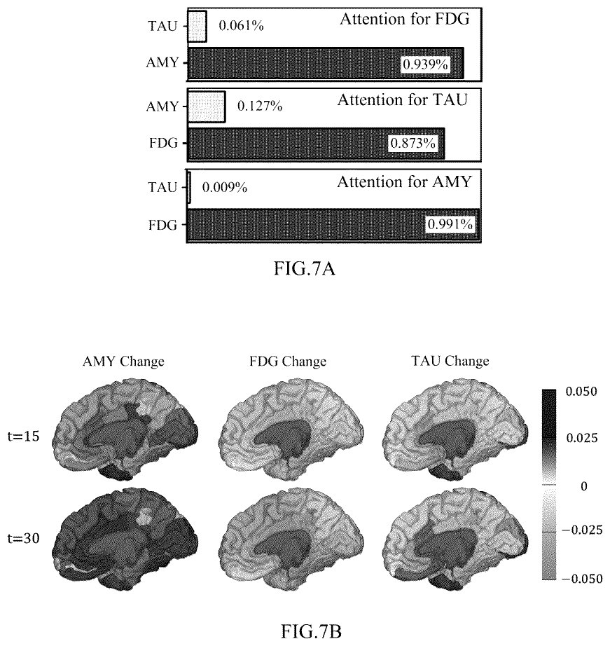

FIGS. 7A-7B illustrate an example of visual information for Alzheimer's biomarker prediction results. FIGS. 7A-7B are information extracted through attention weight analysis.

FIG. 7A visualizes the contribution ratio of other modalities in predicting each of FDG, beta-amyloid, and tau protein. FIG. 7B shows how the average prediction change from other modalities (AMY, TAU) changes over time when predicting FDG. FIG. 7B shows the average rate of change at time t∈[15,30]. Looking at FIG. 7B, changes in beta-amyloid and tau protein were prominent in Alzheimer's-specific regions.

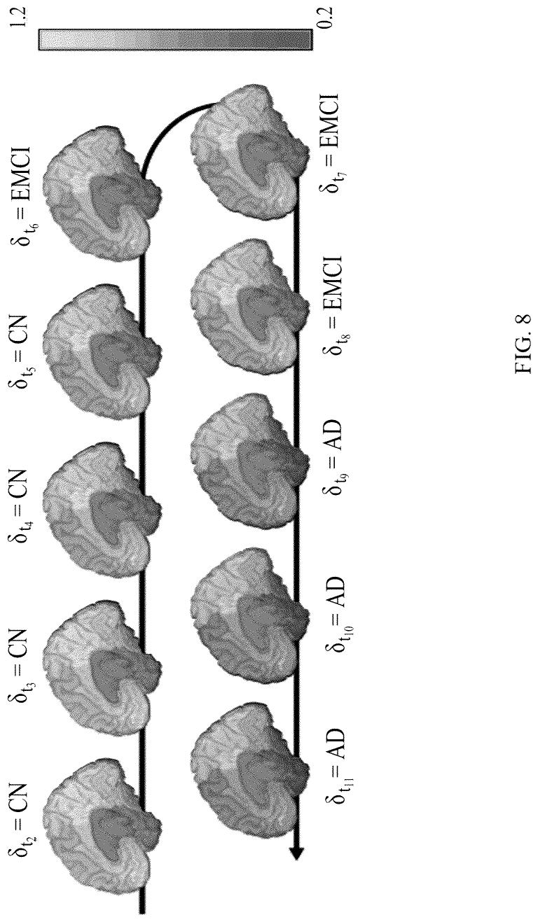

FIG. 8 illustrates FDG predicted over time in brain regions of interest. FIG. 8 visualizes predicted longitudinal decreases in FDG SUVR. FDG decreases overall over time, showing a marked decrease particularly at the time point (t=9) when changing from EMCI to AD.

The aforementioned future time point event technique can be utilized in various application fields.

### (1) Medical Field

Events can be changes in patient condition or disease occurrence. The analysis device may predict the progression stage of disease at future time points by receiving patient medical images and diagnostic history. The analysis device can generate a diagnostic report based on prediction results for the patient. The diagnostic report can include disease progression over time, imaging plans according to prediction results, treatment drug administration plans, etc.

At this time, the analysis device can collect patient data from hospital PACS (Picture Archiving and Communication System) servers or medical imaging equipment and visually provide predicted event results to medical staff terminals.

### (2) Financial Field

Events can be stock price changes, exchange rate changes, etc. The analysis device may predict the timing and type of event occurrence at future time points based on financial data. For example, the analysis device may predict stock prices at future time points. The analysis device can generate a financial report based on prediction results. The financial report can include trading restriction orders, order readjustment orders, financial product order timing and quantities, etc.

At this time, the analysis device can receive market data collected from exchange APIs (Application Programming Interfaces) as input, calculate the event occurrence probability of specific stock price changes, and transmit prediction results to a trading decision-making server.

### (3) E-Commerce Field

Events can be product purchases, adding products to cart, etc. The analysis device may predict the timing and type of event occurrence at future time points based on user log data. For example, the analysis device may predict the purchase conversion probability of specific products based on user purchase history, etc. The analysis device can generate a product management report based on prediction results. The product management report can include product recommendation priorities, product purchase orders, etc.

At this time, the analysis device can monitor user events such as purchases, cart additions, and review writing in real-time, predict future purchase possibilities and transmit them to a recommendation server to perform automatic recommendations and inventory optimization.

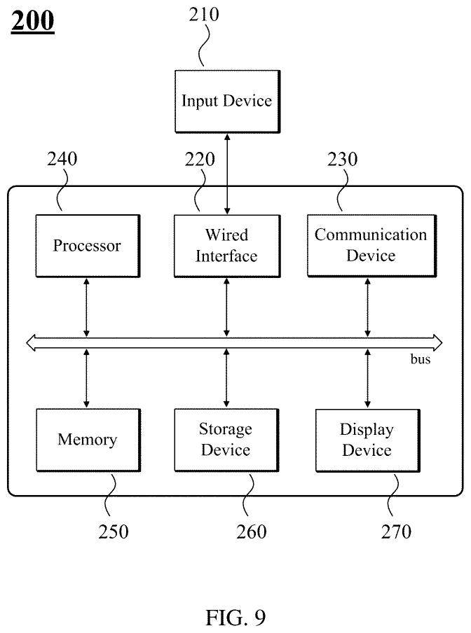

FIG. 9 illustrates an example of a hardware device 200 that predicts events. Hardware device 200 corresponds to an analysis device (130 and 140 in FIG. 1). Hardware device 200 can transmit event prediction results to external devices to perform specific actions in the real world. The actions may include, for example, treatment planning, diagnostic support, trading, product recommendation, and inventory control.

Hardware device 200 can be physically implemented in various forms. For example, hardware device 200 can have the form of a computer device such as a PC, a network server, a dedicated chipset for data processing, an FPGA, etc.

Hardware device 200 may include input device 210, wired interface 220, communication device 230, processor 240, memory 250, and storage device 260.

Also, hardware device 200 may include input device 210, wired interface 220, communication device 230, processor 240, memory 250, storage device 260, and display device 270.

Each internal component of hardware device 200 can be connected by a bus. The bus may be a specific bus depending on the type of connected entities. For example, the bus can be any one of AMBA (AHB/AXI/APB), PCIe, SPI (Serial Peripheral Interface), or MIPI (Mobile Industry Processor Interface).

Input device 210 is a device that receives user commands or necessary data. Also, input device 210 may be a device that receives necessary data from physically connected external devices or storage devices.

Input device 210 can receive event history information. Event history information includes information about multiple events. Event history information corresponds to a past event sequence including occurrence time and event type for each event.

Input device 210 can be any one of various types of devices. For example, input device 210 can be at least one of a mouse, keyboard, touch input device, camera, Small Computer System Interface (SCSI) device, Peripheral Component Interconnect (PCI) bus-based device, or ATA Packet Interface (ATAPI) device.

Wired interface 220 is a device component that transfers data delivered by input device 210 into the device. Wired interface 220 can consist of software drivers and hardware.

Wired interface 220 may include controllers corresponding to each input device, device drivers that control the operation of the controllers, and a kernel I/O subsystem that comprehensively manages input/output control requests of device drivers. The kernel I/O subsystem stores input/output requests from device drivers in a queue and schedules those requests based on request priority or device status.

Wired interface 220 may include interfaces such as PS/2, USB (Universal Serial Bus), Ethernet port, HDMI, MIPI CSI, DisplayPort, Thunderbolt, etc.

Wired interface 220 may also transmit prediction results for event occurrence to external devices.

Communication device 230 refers to a component that receives and transmits certain information through external wired or wireless networks. Communication device 230 can consist of circuits including an antenna and communication modules (S/W module, chip, etc.) corresponding to communication protocols. Communication protocols can be at least one of wired LAN (Ethernet), wireless LAN (IEEE 802.11), mobile communication (LTE, 5G NR, etc.), Bluetooth, NFC, etc.

Communication device 230 can receive event history information from external objects.

Communication device 230 can transmit prediction results for event occurrence or event reports to external objects.

Processor 240 controls the operation of various components of hardware device 200.

Processor 240 can perform operations for at least one application or computer program for executing methods/operations according to various embodiments of the present disclosure.

Processor 240 is a general-purpose processor that executes at least part of control programs installed in storage device 260 or at least part of programs loaded in memory 250.

Processor 240 can be implemented as circuitry (e.g., processing circuitry) such as a system on chip (SoC) or integrated circuit (IC).

Processor 240 may include one or more processors. For example, processor 240 may include a combination of one or more processors such as a central processing unit (CPU), microprocessor unit (MPU), micro controller unit (MCU), graphic processing unit (GPU), neural processing unit (NPU), digital signal processor (DSP), application processor (AP), communication processor (CP), or any type of processor well known in the technical field of the present disclosure.

Memory 250 can store data and information generated in the process of predicting events. Memory 250 is volatile memory such as DRAM or SRAM.

Storage device 260 can store the aforementioned neural ordinary differential equation model.

Storage device 260 can store predicted event occurrence information (event occurrence time and event type).

Storage device 260 can store an event report including predicted event occurrence information.

Storage device 260 can be implemented as a device such as a hard disk drive, Solid State Drive, USB flash drive, memory card, optical disk, or network-based storage device (Network Attached Storage, cloud storage, etc.).

Display device 270 can output interfaces necessary for the analysis process, past event history, predicted event occurrence information, influences of past events, interrelationships between events, etc.

Display device 270 can be implemented as various types of devices.

Display device 270 can be implemented with various display methods such as liquid crystal, plasma, light-emitting diode, organic light-emitting diode, surface-conduction electron-emitter, carbon nano-tube, nano-crystal, etc.

Processor 240 can generate an initial hidden state according to event type for each of events included in a past event sequence. Processor 240 can compute the initial hidden state as shown in Equation 6.

Processor 240 may develop hidden states by applying the initial hidden state to a neural ordinary differential equation for each of events included in a past event sequence.

Processor 240 may develop hidden states of events in parallel as shown in Equation 7 using neural ordinary differential equations.

Processor 240 can compute a ground intensity function by combining influence functions of events. Processor 240 can compute the ground intensity function using influence functions as shown in Equation 8. Also, processor 240 can compute the ground intensity function by combining influence functions of events using Equation 11.

Processor 240 can compute a probability distribution of event types (marks) by combining influence functions of events. Processor 240 can compute the probability distribution of marks using influence functions as shown in Equation 10. Also, processor 240 can compute the probability distribution of marks by combining influence functions of events using Equation 12.

Processor 240 may predict an event occurrence time and event type at a future time based on the ground intensity function and the probability distribution of event types.

Processor 240 can compute a compensator by integrating the ground intensity function over time and predict the event occurrence time and event type at the future time using the compensator. Processor 240 can calculate the compensator by integrating the intensity function. Thereafter, processor 240 can calculate the event occurrence probability density function, survival function, and expected time point using the compensator.

The non-transitory computer readable medium refers to a medium that stores data semi-permanently (e.g., the storage device 310) and is capable of being read by a device, rather than a medium that stores data for a short period of time, such as a register, cache, or memory. Specifically, the various applications or programs described above may be provided by being stored in the non-transitory computer readable medium such as a CD, a DVD, a hard disk, a Blu-ray disk, a USB, a memory card, a read-only memory (ROM), a programmable read only memory (PROM), an erasable PROM (EPROM), an electrically EPROM (EEPROM), or a flash memory.

The transitory computer readable medium refers to various types of RAM such as a static RAM (SRAM), a dynamic RAM (DRAM), a synchronous DRAM (SDRAM), a double data rate SDRAM (DDR SDRAM), an enhanced SDRAM (ESDRAM), a synclink DRAM (SLDRAM), and a direct Rambus RAM (DRRAM).

Various examples and aspects of the present disclosure are described below. These are provided as examples, and do not limit the scope of the present disclosure.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide examples of the technical features of the present disclosure for illustrative purposes. In other words, the disclosed embodiments are intended to illustrate the scope of the technical features of the present disclosure. Thus, the scope of the present disclosure is not limited to the embodiments shown, but is to be accorded the widest scope consistent with the claims. The scope of protection of the present disclosure should be construed based on the following claims, and all technical features within the scope of equivalents thereof should be construed as being included within the scope of the present disclosure.

What is claimed is:

1. A method for predicting an event occurrence using a decoupled marked temporal point process, comprising:
receiving, by a hardware apparatus, a past event sequence including occurrence times and event types for each of the events included in the past event sequence;
generating, by the hardware apparatus, an initial hidden state according to an event type for each of the events included in the past event sequence;
decoding, by the hardware apparatus, influence functions of the events over time from the initial hidden state using a neural ordinary differential equation model;
computing, by the hardware apparatus, (i) a ground intensity function and (ii) a probability distribution of the event types by respectively combining the influence functions of the events in a first manner and in a second manner;
predicting, by the hardware apparatus, an event occurrence time and event type at a future time based on the ground intensity function and the probability distribution of the event types; and
providing, by the hardware apparatus, an event report including the event occurrence time and event type to an external system configured to consume the event report to trigger predetermined control or decision workflows.

2. The method of claim 1, wherein the hardware apparatus develops hidden states in parallel for the events using the neural ordinary differential equation model, and computes the influence functions by decoding the developed hidden states.

3. The method of claim 1, wherein the hardware apparatus computes the ground intensity function by softplus transforming the influence functions and summing resulting values.

4. The method of claim 1, wherein the hardware apparatus computes the probability distribution of the event types by softmax-normalizing the influence functions over the event types.

5. The method of claim 1, wherein the hardware apparatus computes a compensator by integrating the ground intensity function over time, and predicts the event occurrence time and event type at the future time using the compensator.

6. The method of claim 1, wherein the neural ordinary differential equation model is trained to maximize likelihood of Marked Temporal Point Process (MTPP).

7. A hardware device for predicting event occurrence, comprising:
a storage device that stores a past event sequence including occurrence times and event types for each of past events;
a processor that develops hidden states by applying initial hidden states to a neural ordinary differential equation for each of the events, derives influence functions over time by decoding each of the developed hidden states, computes a ground intensity function by combining the influence functions of the events in a first manner, computes a probability distribution of the event types by combining the influence functions of the events in a second manner, and predicts an event occurrence time and event type at a future time based on the ground intensity function and the probability distribution of the event types; and
a communication device that transmits an event report including the event occurrence time and event type to an external system that performs real-world actions.

8. The hardware device of claim 7, wherein the processor develops hidden states in parallel for the events using the neural ordinary differential equation.

9. The hardware device of claim 7, wherein the processor computes the ground intensity function by softplus transforming the influence functions and summing resulting values.

10. The hardware device of claim 7, wherein the processor computes the probability distribution of the event types by softmax-normalizing the influence functions over the event types.

11. The hardware device of claim 7, wherein the processor computes a compensator by integrating the ground intensity function over time, and predicts the event occurrence time and event type at the future time using the compensator.

12. The hardware device of claim 7, wherein the neural ordinary differential equation is trained to maximize likelihood of Marked Temporal Point Process (MTPP).

13. A non-transitory computer-readable recording medium storing a program for executing on a computer the method for predicting event occurrence using decoupled marked temporal point process according to claim 1.
